(19) United States
(12) Patent Application Publication
(10) Pub. No.: US 2002/0028593 A1
(43) Pub. Date: Mar. 7, 2002

(54) Plug-side connector structure for high-voltage cable

(75) Inventors: Takehito Uchiyama, Yokkaichi-city (JP); Hisao Imanishi, Yokkaichi-city (JP)

Correspondence Address: GREENBLUM & BERNSTEIN, P.L.C., 1941 ROLAND CLARKE PLACE, RESTON, VA, 20191, US

(73) Assignee: SUMITOMO WIRING SYSTEMS, Ltd., Yokkaichi-city (JP)

(21) Appl. No.: 09/942,725

(22) Filed: Aug. 31, 2001

(30) Foreign Application Priority Data
Sep. 4, 2000 (JP) JP2000-266837

(51) Int. Cl. H01R 13/44

(52) U.S. Cl. 439/125

(57) ABSTRACT

In the plug-side connector structure for high-voltage terminal, the terminal tip of a spark plug can be inserted and fitted into a high-voltage terminal structure very smoothly. The high-voltage terminal structure includes a plug-fit system, and the entire structure is contained in a boot. The plug-fit system includes a tapered guide, which extends outwardly while enlarging in the radial direction of the plug-fit system. The boot includes a terminal enclosure and a glass- or ceramic-portion enclosure, between which a circular recess is provided. The high-voltage terminal structure is thus held in the terminal enclosure by fitting the tapered guide into the circular recess.

### BACKGROUND OF THE INVENTION

1. Field of the Invention

The present invention generally relates to a plug-side connector structure for a high-voltage electrical cable. The latter connects an ignition coil to a spark plug for an internal-combustion engine of a vehicle, e.g., an automobile.

2. Description of Background Information

FIG. 1 shows such a plug-side connector structure known in the prior art.

In the above structure, a high-voltage terminal structure 102 is mounted at an end portion of a high-voltage cable 101. At the other end, a spark plug P is provided with a terminal tip Pt and a glass or ceramic portion Pg (generically designated hereafter by the term “glass portion”. The high-voltage terminal structure 102 and the terminal tip Pt and glass portion Pg of the spark plug are contained in a boot or shroud 105 made, e.g., of rubber. The high-voltage terminal structure 102 and peripheral devices are thus electrically insulated, and an electrical current is prevented from leaking out along the glass portion surface of the spark plug P.

When mounting the above plug-side connector structure, the high-voltage terminal structure 102 of the high-voltage cable 101 is first inserted into the boot 105 from one of its sides. The terminal tip Pt and glass portion Pg of the spark plug P are then inserted into the boot 105 from the opposite side, so that the terminal tip Pt is fitted into the high-voltage terminal structure 102 inside the boot 105.

However, because the boot 105 is formed of an elastic material e.g. rubber, it lacks rigidity. In particular, when the high-voltage terminal structure 102 is installed in the boot 105, its remaining portion tends to be insufficiently rigid. Thus, when the terminal tip Pt and glass portion Pg of the spark plug P are inserted into the boot 105, the latter is easily deformed. The terminal tip Pt and glass portion Pg may then be moved into the boot 105 diagonally (FIG. 2), whereupon the terminal tip Pt may abut against the open edge of the high-voltage terminal structure 102. Matching of the two connection edges thus becomes difficult. Further, when the terminal tip Pt is forcibly inserted, the high-voltage terminal structure 102 itself may be deformed.

When the deformed high-voltage terminal structure is repeatedly used, the high-voltage terminal structure 102 and the terminal tip Pt will be partially worn out, and the conductivity between them will deteriorate. As a result, the internal-combustion engine can fail to fire or stall.

An object of the present invention is therefore to provide a plug-side connector structure, in which the terminal tip of the spark plug can be smoothly inserted into, and connected to, the high-voltage terminal structure.

### SUMMARY OF THE INVENTION

To this end, there is provided a plug-side connector structure for a high-voltage cable including a boot, the boot having a substantially cylindrical form with first and second ends and containing a high-voltage terminal structure attached to an end of the high-voltage cable which extends outwardly through the first end of the boot. The boot is configured to receive, through the second end thereof, a terminal tip and a subsequent glass or ceramic portion of a spark plug such that the terminal tip can be fitted into the high-voltage terminal structure.

The boot includes a terminal enclosure for containing the high-voltage terminal structure, and a glass- or ceramic-portion enclosure configured to contain the glass or ceramic portion and located adjacent the second end of the boot.

The high-voltage terminal structure includes a cable connector system connected to the one end of the high-voltage cable, and a plug-fit system.

The plug-fit system includes a fitting body having a cylindrical form and configured to receive the terminal tip.

The plug-fit system further includes a guide device that guides the terminal tip into the fitting body.

Preferably, the guide device includes a tapered guide extending from the fitting body toward the second end of the boot while enlarging in the radial direction of the fitting body so as to form a flared end.

The flared end of the tapered guide has an outermost external diameter greater than the internal diameter of the glass- or ceramic-portion enclosure.

Further, the glass portion enclosure and the terminal enclosure respectively include an internal circular face, between which is provided a circular recess, such that, when the high-voltage terminal structure is contained in the terminal enclosure, the tapered guide is fitted into the circular recess.

Preferably yet, the cylindrical form of the fitting body has a given external diameter, such that the outermost external diameter of the tapered guide is about 1.4 to about 1.6 times greater than the external diameter of the fitting body.

Typically, the cylindrical form of the fitting body has a longitudinally extending surface line, and the tapered guide has an external taper angle which is defined relative to the longitudinally extending surface line of the fitting body, such that the external taper angle of the tapered guide ranges between about 120° and about 150°.

Alternatively, the tapered guide may be formed of a plurality of fins separated from one another in the circumferential direction of the tapered guide, and include a slit flared end equivalent to the flared end having the outermost external diameter described above.

Suitably, the above guide device includes a tapered guide extending from the fitting body towards the second end of the boot while enlarging in the radial direction of the fitting body so as to form a flared end.

Then, the flared end has an outermost external diameter substantially the same as the internal diameter of the glass- or ceramic-portion enclosure, such that, when the high-voltage terminal structure is contained in the terminal enclosure, the circular edge is hermetically attached to the internal circular face of the glass- or ceramic-portion enclosure.

Suitably yet, the guide device includes a cylindrical guide having a common cylinder axis with the fitting body, the cylindrical guide being fitted around the fitting body.

The cylindrical guide is then extendable from the fitting body along the common cylinder axis so as to be contained in the glass- or ceramic-portion enclosure, and retractable such that, when the terminal tip and glass or ceramic portion are inserted into the boot, the cylindrical guide can be pushed into the boot by the glass or ceramic portion and the terminal tip can be led into the fitting body, whereby the high-voltage terminal structure is held in the terminal enclosure.

### BRIEF DESCRIPTION OF THE DRAWINGS

The above, and the other objects, features and advantages of the present invention will be made apparent from the following description of the preferred embodiments, given as non-limiting examples, with reference to the accompanying drawings, in which:

FIG. 1 is a partial sectional elevation view of a plug-side connector structure for a high-voltage terminal, known in the prior art;

FIG. 2 is a partial sectional elevation view of a plug-side connector structure for a high-voltage terminal, when it is connected to a spark plug;

FIG. 3 is a sectional elevation view of a plug-side connector structure for a high-voltage terminal, according to a first embodiment of the invention;

FIG. 4 is an enlarged partial view of a plug-fit system in the plug-side connector structure for a high-voltage terminal of FIG. 3;

FIG. 5 is a partial sectional elevation view of the plug-side connector structure for a high-voltage terminal of FIG. 3, when the plug-fit system is being connected with a spark plug;

FIG. 6 is a partial sectional elevation view of a plug-side connector structure for a high-voltage terminal, according to a second embodiment of the invention;

FIG. 7A is an enlarged partial elevational view of the plug-fit system, according to a variant of the first embodiment;

FIG. 7B is an enlarged partial bottom plan view of the plug-fit system, according to the variant of the first embodiment of FIG. 7A;

FIG. 8 is a partial sectional elevation view of a plug-side connector structure for a high-voltage terminal, according to a third embodiment of the invention;

FIG. 9A is a sectional elevational view of the plug-fit system of FIG. 8, when a cylindrical guide is extended from a fitting body;

FIG. 9B is sectional elevational view of the plug-fit system of FIG. 8, when the cylindrical guide is retracted to the fitting body; and

FIG. 10 is a partial sectional elevational view of the plug-side connector structure for a high-voltage terminal according to the third embodiment, when it is fitted with a spark plug.

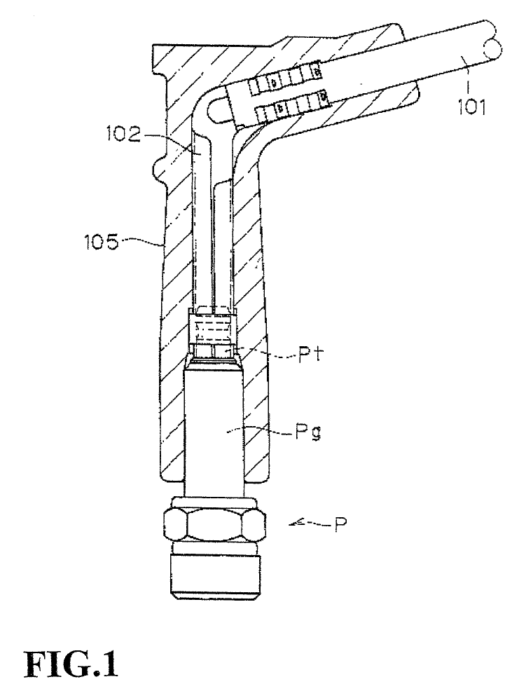

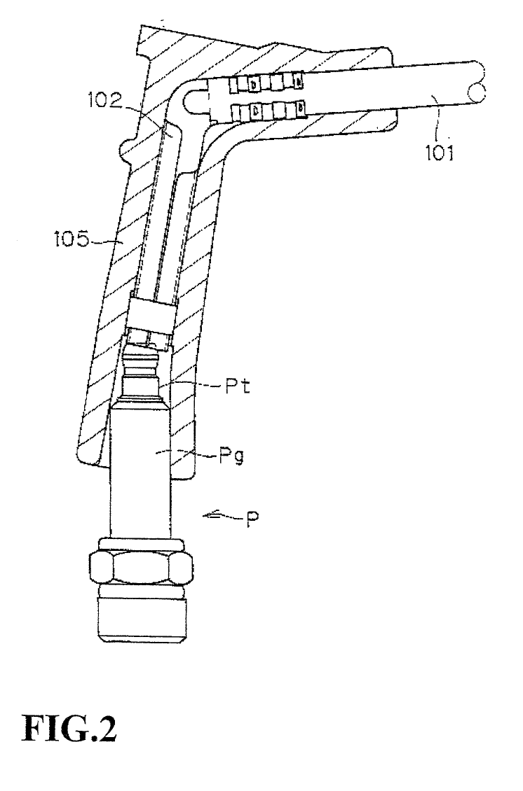

### DETAILED DESCRIPTION OF THE PREFERRED EMBODIMENTS

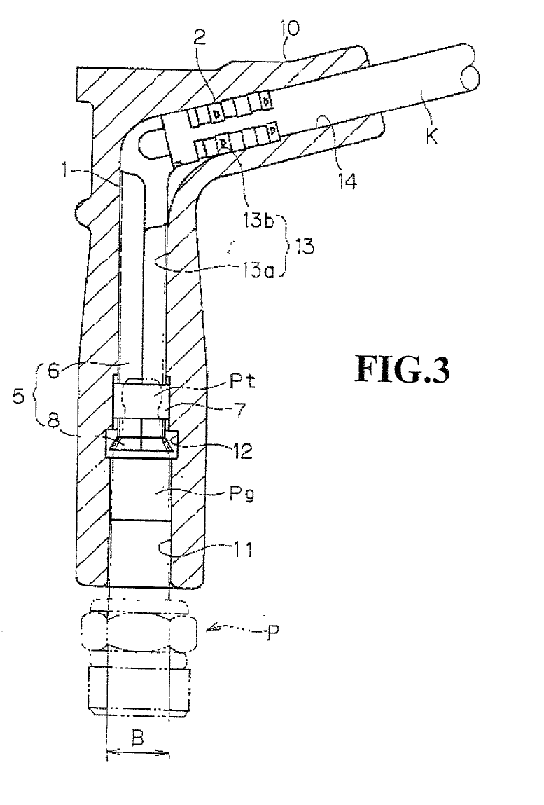

In a first embodiment shown in FIG. 3, the plug-side connector structure for high-voltage cable includes a high-voltage terminal structure 1 attached to an end portion of a high-voltage cable K drawn out from, e.g., an ignition coil, and a boot 10 having a cylindrical shape containing the high-voltage terminal structure 1. A knob-like terminal tip Pt projects from a spark plug P provided at the side of an internal-combustion engine. This terminal tip Pt, together with a glass or ceramic portion (hereafter referred to generically as a glass portion) Pg extending therefrom, is inserted into the boot 10 from the side opposite the ignition coil, and connected to the high-voltage terminal structure 1 inside the boot 10.

The high-voltage terminal structure 1 is stamped and formed from a metal sheet. A cable connector system 2 is attached to an end portion of the high-voltage cable K, and a plug-fit system 5 is adapted to fit to the terminal tip Pt of the spark plug P. The cable connector system 2 and the plug-fit system 5 have a substantially inverted “L” configuration.

The cable connector system 2 is configured so as to fasten the end portion of the high-voltage cable K by clamping or crimping. The end portion of the high-voltage cable K is initially stripped of its coating to expose the cable's core wire. The bared core wire is folded back over a portion of the length of the coating. The whole cable-end structure is then clamped or crimped by the cable connector system, so that the core wire of the high-voltage cable K is connected to the high-voltage terminal structure 1.

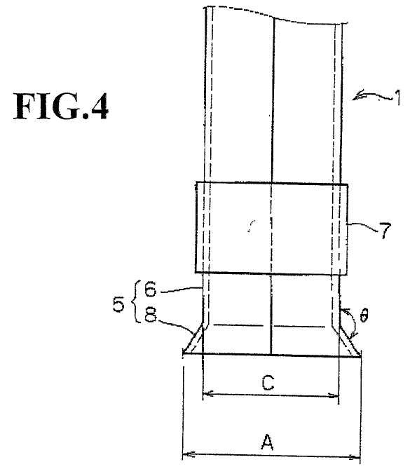

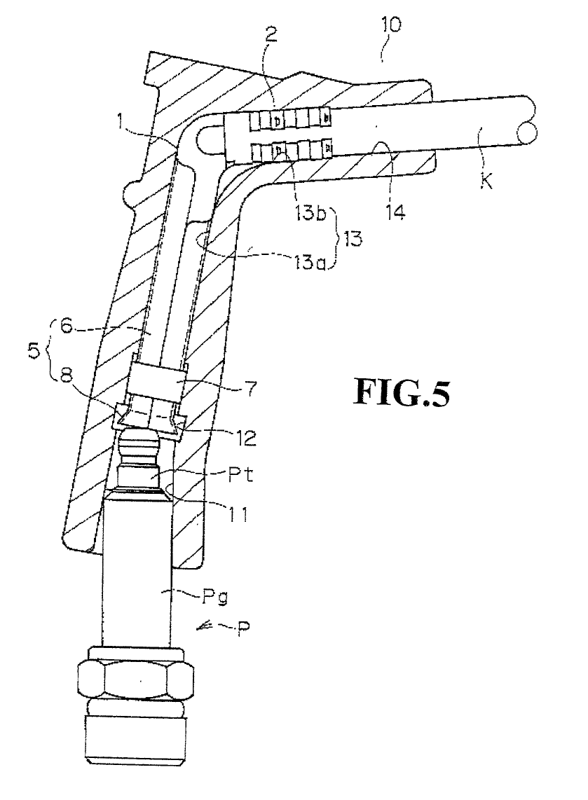

As shown in FIGS. 3 and 4, the plug-fit system 5 includes a tubular fitting body 6 into which the terminal tip Pt can be inserted, and a tapered guide 8 formed at the opening (bottom end in FIG. 3) of the fitting body 6.

The fitting body 6 is formed by rounding a metal sheet, and has a substantially tubular shape, the inner diameter of the tube being arranged to press-fit with the terminal tip Pt. Thus, the terminal tip Pt can be electrically connected to the high-voltage terminal structure 1 by press-fitting the terminal tip Pt into the fitting body 6 through the tapered guide 8.

In the present embodiment, the fitting body 6 is wrapped with a substantially C-shaped elastic ring 7 which prevents the body from swelling and ensures more reliable connections between the fitting body 6 and the terminal tip Pt.

The tapered guide 8 is formed as an extension of the fitting body 6, and enlarges towards its open end (downwards in FIGS. 3 and 4). The outermost end of the tapered guide 8 has an external diameter A, which is larger than the diameter of a glass-portion (or ceramic-portion) enclosure 11 (described infra). When the terminal tip Pt is passed through the glass-portion enclosure 11, the terminal tip Pt slides along the internal tapered face of the tapered guide 8 and is guided into the fitting body 6.

The boot 10 is made of any suitable elastic insulator material such as rubber. It is formed into an inverted L shaped cylindrical form.

The boot 10 includes the glass-portion enclosure 11 extending inwardly from one of its ends (hereafter designated second end), through which the glass portion Pg is passed. It further includes a draw-out path 14 which extends substantially horizontally (as viewed in FIG. 3), from the elbow portion of the L-shaped boot 10 towards its other (first) end. The portion between the glass-portion enclosure 11 and the draw-out path 14 forms a terminal enclosure 13 configured to contain the high-voltage terminal structure 1.

The glass-portion enclosure 11 has an internal face shaped to correspond to the external face shape of the glass portion Pg, so that the latter can be contained hermetically therein. In this manner, electrical current is prevented from leaking out along the glass portion surface.

The terminal enclosure 13 includes an inverted generally L-shaped hole, corresponding to the shape of the high-voltage terminal structure 1. The terminal enclosure 13 includes a plug-fit system enclosure 13a, which is located below the elbow portion and configured to contain the fitting body 6 in the plug-fit system 5 of the high-voltage terminal structure 1. The terminal container hole 13 further includes a cable connector system enclosure 13b, which extends horizontally from the elbow portion and is adapted to contain the cable connector system 2 of the high-voltage terminal structure 1. Accordingly, the high-voltage terminal structure 1 is arranged in the boot 10 by press-fitting it into the terminal enclosure 13.

The plug-fit system enclosure 13a has an internal diameter (e.g. 7.2 mm) substantially corresponding to, or slightly smaller than, the external diameter of the fitting body 6 of the plug-fit system 5. Thus, when the fitting body 6 is press-fitted into the plug-fit system enclosure 13a, the fitting body 6 can be held at a predetermined position. However, at the level of the portion of fitting body 6 where the ring 7 is fitted, the internal diameter of the plug-fit system enclosure 13a is made slightly larger than the remaining part, taking into account the larger diameter of the ring 7.

The internal face of the boot 10, located between the glass-portion enclosure 11 and the terminal enclosure 13, is provided with a circular recess 12. The latter has an internal diameter larger than the external diameter A of the outermost edge of the tapered guide 8, so that the tapered guide 8 of the high-voltage terminal structure 1 can be contained in the circular recess 12.

The draw-out path 14 is formed in extension of the cable connector system enclosure 13b of the terminal enclosure 13. The high-voltage cable K, connected to the cable connector 2 in the cable connector system enclosure 13b, can be drawn out through the draw-out path 14.

When the plug-side connector structure is mounted, the high-voltage terminal structure 1 is first attached to one end of the high-voltage cable K. The other end of the high-voltage cable K is then inserted into the boot 10 from below (i.e. from the second end of the boot). It passes through the glass-portion enclosure 11 and the terminal enclosure 13, and is drawn out from the draw-out path 14. By elastically deforming the boot 10, the high-voltage terminal structure 1 is pushed deeply into the boot 10, and the tapered guide 8 is fitted into the circular recess 12, whereby the high-voltage terminal structure 1 is snugly fitted into the terminal enclosure 13.

The plug-side connector structure for the high-voltage cable K is then connected to the spark plug P as described below.

The terminal tip Pt and glass portion Pg of the spark plug P, installed in an internal-combustion engine, are inserted into the boot 10 from its second end. The terminal tip Pt then passes through the glass-portion enclosure 11 and fits into the plug-fit system 5, and the glass portion Pg fits into the glass-portion enclosure 11. During this process, the boot 10 may be considerably distorted, and the terminal tip Pt may be inserted into the plug-fit system 5 biased or askew with respect to the high-voltage terminal structure 1. In that event, the terminal tip Pt abuts the internal face of the tapered guide 8, and is guided into the fitting body 6. In addition, the terminal tip Pt is prevented from hooking with the opening edge of the plug-fit system 5 of the high-voltage terminal structure 1, and the terminal tip Pt and the plug-fit system 5 can be fitted together very smoothly.

In the above first embodiment, the tapered guide 8 of the high-voltage terminal structure 1 is fitted into the circular recess 12 formed at a position between the glass-portion enclosure 11 and the terminal enclosure 13. In such a structure, the outermost edge of the tapered guide 8 may have an external diameter A substantially greater than the hole diameter B of the glass-portion enclosure 11. As mentioned above, the terminal tip Pt can then be guided into the fitting body 6 very smoothly.

Typically, the external diameter A of the outermost edge of the guide 8 is set at a value greater than, preferably at about 1.4 to about 1.6 times, the external diameter C of the fitting body 6. Likewise, the external taper angle θ of the tapered guide 8 is set at a value suitable for guiding the terminal tip into the fitting body, preferably between about 120° and about 150°.

When the external diameter A is smaller than about 1.4 times the external diameter C of the fitting body 6 and the terminal tip Pt is inserted diagonally, the latter cannot be efficiently guided into the fitting body.

Conversely, when the external diameter A is greater than about 1.6 times the external diameter C of the fitting body 6, the high-voltage terminal structure 1 is mounted into the boot 10 less easily.

When the external taper angle θ is smaller than about 120° and the terminal tip Pt is inserted diagonally, the latter cannot be efficiently guided into the fitting body 6.

Conversely, when the external taper angle θ is greater than about 150°, the tapered guide 8 must be lengthened as a function of the external diameter A. As a result, the boot 10 must also be lengthened, thus lowering its rigidity.

A second embodiment of the present invention is now described, in which the structure components common with those of the first embodiment are referred to with the same numerals. Only the different points from the first embodiment are specifically mentioned.

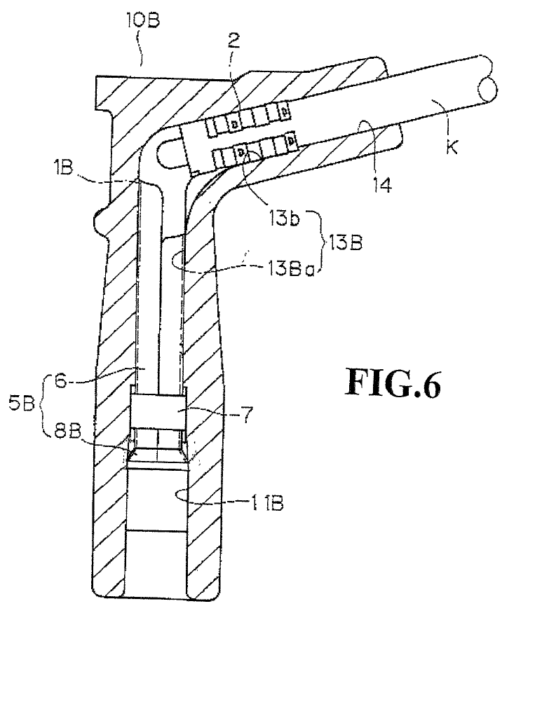

In the second embodiment, there is no circular recess 12 between the glass-portion enclosure 11 and the terminal enclosure 13. Instead, as shown in a boot 10B of FIG. 6, a glass-portion enclosure 11B, and a plug-fit system enclosure 13Ba of a terminal enclosure 13B are directly connected to each other.

Further, a plug-fit system 5B of a high-voltage terminal structure 1B includes a tapered guide 8B. Its outermost edge has an external diameter substantially the same as the internal diameter of a glass portion enclosure 11B.

Furthermore, the high-voltage terminal structure 1B is held by the terminal enclosure 13B, while the circular rim of the outermost edge of the tapered guide 8B is closely placed into contact with the internal face of the glass-portion enclosure 11B.

In the above plug-side connector structure of the second embodiment, the fitting body 6 includes a tapered guide 8B, as in the case of the first embodiment. Accordingly, the terminal tip Pt can be led into the plug-fit system 5 of the high-voltage terminal structure 1 as smoothly as in the case of the first embodiment.

In particular, as the circular rim of the outermost edge of the tapered guide 8B is firmly placed into contact with the internal circular face of the glass portion enclosure 11B, the internal circular face of the tapered guide 8B continuously extends from the latter. Therefore, when the plug-fit system 5B is inserted into the glass portion enclosure 11B, it is directly and securely led into the tapered guide 8B, and then into the fitting body 6. The terminal tip Pt is thus reliably guided into the plug-fit system 5 of the high-voltage terminal structure 1 by the tapered guide 8B.

The first and second embodiments may include variant embodiments as explained below.

Typically, the tapered guides 8 and 8B are prepared by stretching an end portion of a sheet. However, such a process can make the stretched sheet too thin, and its mechanical strength too weak. Moreover, the stretching operation is a rather difficult operation.

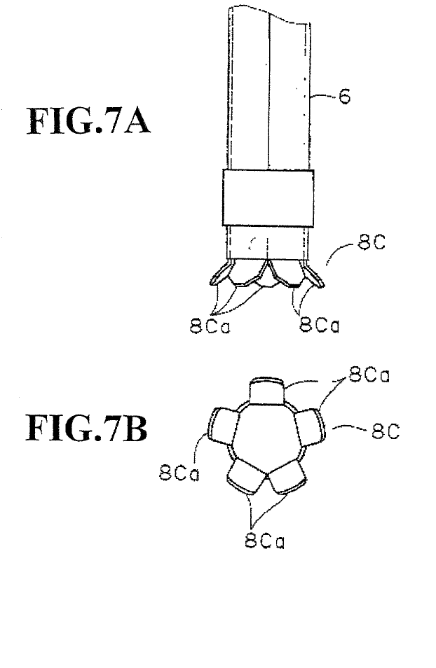

FIGS. 7A and 7B show an alternative solution to this. In these figures, a tapered guide 8C is formed of a plurality of flared fins 8Ca (e.g. petal form), which extend from the end portion of the fitting body 6 towards its opened end while expanding outwardly in the radial direction.

Such a tapered guide 8C may be prepared before or after a sheet is rounded to form a fitting body 6. In particular, an end portion of the sheet is cut out and bent outwardly, such as to form petal-like fins. This manufacturing method is simple and gives uniformly thick pieces.

A third embodiment of the invention is now described hereafter.

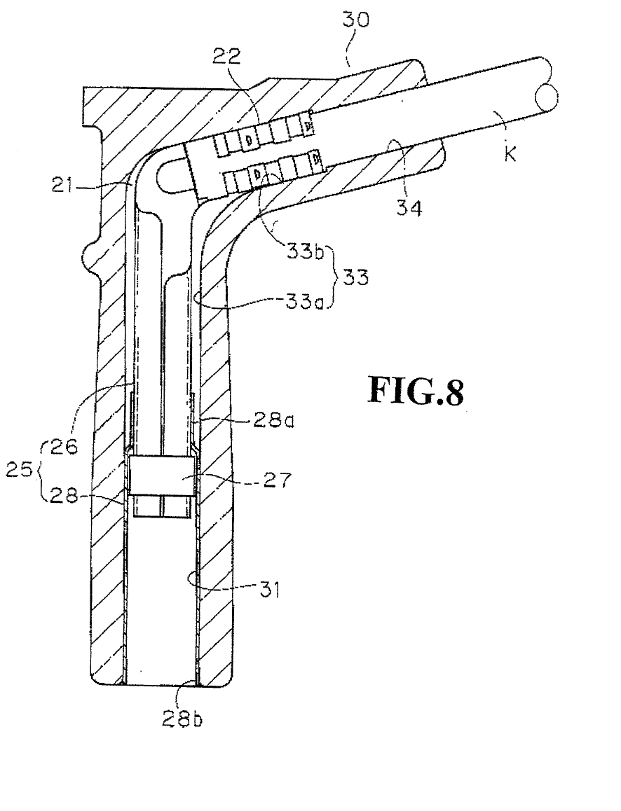

The plug-side connector structure of the third embodiment is shown in FIG. 8, in which there is provided a high-voltage cable K extending from e.g. an ignition coil, a high-voltage terminal structure 21 attached to one end of the high-voltage cable K, and a boot 30 having a substantially cylindrical form and containing the high-voltage terminal structure 21.

The high-voltage terminal structure 21 is formed by stamping and bending a metal sheet (or plate). The structure 21 includes a cable connector system 22 fixed to an end portion of the high-voltage cable K, and a plug-fit system 25 configured to connect to a terminal tip Pt of a spark plug P, the cable connector system 22 and the plug-fit system 25 being configured in the shape of an inverted L.

The cable connector system 22 is fixed to the end portion of the high-voltage cable K as described for the cable connector system 2 in the first embodiment.

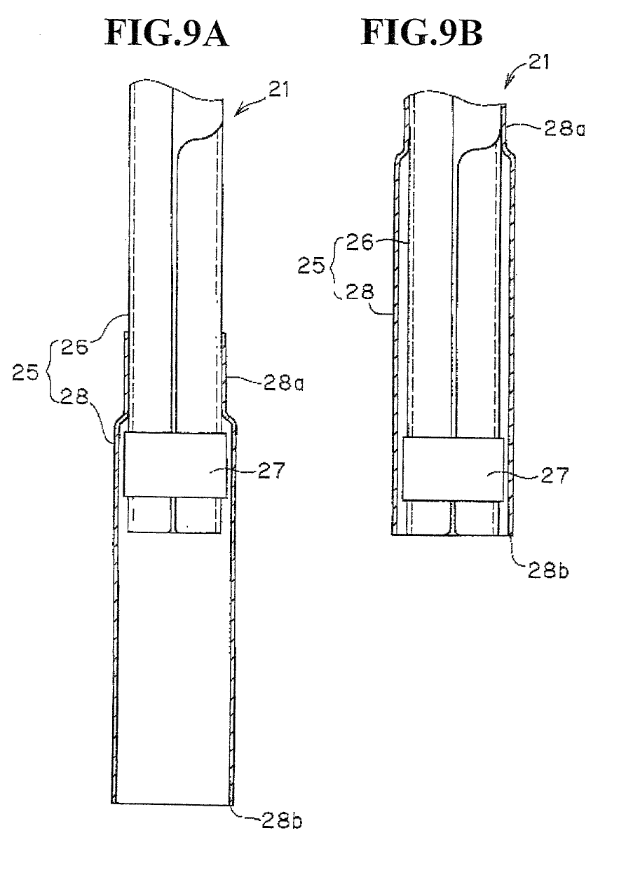

As shown in FIGS. 8, 9A and 9B, the plug-fit system 25 includes a fitting body 26, into which a terminal tip Pt can be inserted, and a cylindrical guide 28 fixed around the fitting body 26.

The fitting body 26 is formed by rounding a metal sheet into a substantially cylindrical shape. When the terminal tip Pt is press-fitted into the fitting body 26, the former is electrically connected to the high-voltage terminal structure 21. A given position adjacent the bottom end of the fitting body 26 is provided with a C-shaped elastic ring 27. This ring is fixed around the fitting body 26 from the outside, and prevents the fitting body 26 from swelling. It also secures the contact between the fitting body 26 and the terminal tip Pt.

The cylindrical guide 28 is also formed by rounding a metal sheet. It is fixed around the fitting body 26, such as to be able to move back and forth along its cylindrical axis with respect to the fitting body 26.

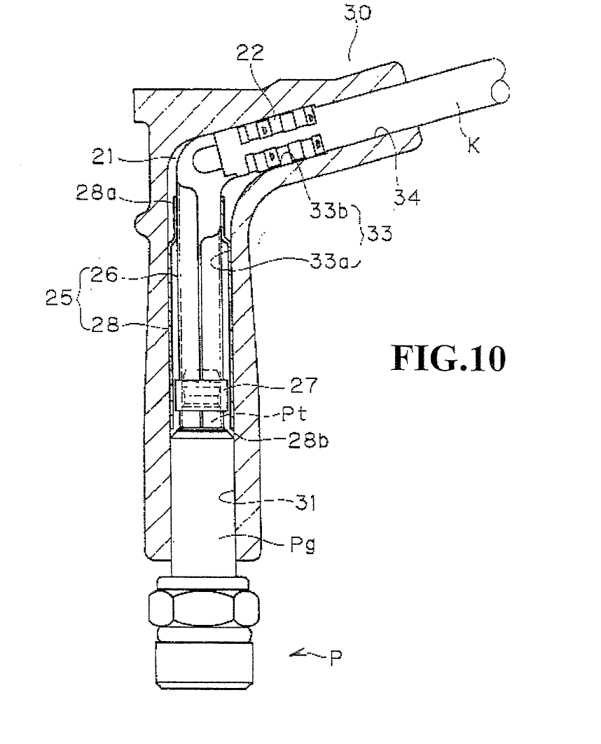

In particular, the lower portion 28b of the cylindrical guide 28 along its length has an internal diameter greater than the external diameter of the ring 27 fixed around the fitting body 26, while the upper portion thereof 28a has an internal diameter which is greater than the external diameter of the fitting body 26, and smaller than the external diameter of the ring 27. The cylindrical guide 28 is thus installed around the fitting body 26 and moved downwardly, until the upper portion 28a having a smaller diameter comes into contact with the ring 27. The lower portion can freely slide up and down, such that its lowermost edge 28b extends further downwardly from the lowermost edge of the fitting body 26 (“extended position” as viewed in FIGS. 8 and 9A), or both lowermost edges come to the same level (“retracted position” as viewed in FIGS. 9B and 10).

When spark plug P is inserted into the boot 30, its terminal tip Pt is fitted into the cylindrical guide 28, and its glass portion Pg comes into contact with the lowermost edge 28b of the cylindrical guide 28. The internal diameter of the cylindrical guide 28 is made greater than the maximum external diameter of the terminal tip Pt and smaller than the external diameter of the glass portion Pg. The cylindrical guide 28 is first extended downwardly (FIG. 9A). The terminal tip Pt is placed into the cylindrical guide 28 from below, while the glass portion Pg comes into contact with the lowermost edge 28b of the cylindrical guide 28. Thereafter, the terminal tip Pt is inserted into the plug-fit system 25, and both are electrically connected. Further, when the terminal tip Pt is pushed upwardly relative to the remaining part, the cylindrical guide 28 is also pushed up by the terminal tip Pt by sliding. As the terminal tip Pt is already installed in the cylindrical guide 28, it is guided towards the fitting body 26 by the sliding movement of the cylindrical guide 28. When the cylindrical guide 28 is moved upwardly up to the completely retracted point, the terminal tip Pt is inserted into the fitting body 26 and electrically connected therein.

The boot 30 is formed of any suitable elastic insulator material, and has a substantially inverted L shape, viewed in an elevated position.

The boot 30 includes, at its lower portion, a glass portion enclosure 31 for holding the glass portion Pg. The boot 30 further includes a draw-out path 34 for a high-voltage cable K, which extends from the elbow portion of the boot along the horizontal portion thereof. Further, a terminal enclosure 33 of the high-voltage terminal structure 21 is provided between the glass portion enclosure 31 and the draw-out path 34.

The above glass portion enclosure 31 can contain the glass portion Pg, as in the case of the glass portion enclosure 11 of the first embodiment.

The terminal enclosure 33 has the shape of a substantially inverted L corresponding to the elbow portion of the high-voltage terminal structure 21. A plug-fit system enclosure 33a located below the elbow portion can contain a plug-fit system 25 of the high-voltage terminal structure 21, while a cable connector system enclosure 33b extending horizontally from the elbow portion can contain a cable connector system 22 of the high-voltage terminal structure 21. The plug-fit system enclosure 33a has an internal diameter substantially the same as that of the glass portion enclosure 31. The high-voltage terminal structure 21 is contained in the terminal enclosure 33, such that the cylindrical guide 28 can slide in and between the plug-fit system enclosure 33a and the glass portion enclosure 31.

The high-voltage terminal structure 21 is contained in the boot 30 by press-fitting the former into the terminal enclosure 33.

The draw-out path 34 is configured such as the draw-out path 14 in the first embodiment, and can be used for drawing out the high-voltage cable K fitted into the high-voltage terminal structure 21.

When constructing the plug-side connector structure, a high-voltage terminal structure 21 is first attached to one end of the high-voltage cable K. The other end of the high-voltage cable K is then led into the boot 30 from its lower end (second end), and passed successively through the glass portion enclosure 31 and the terminal enclosure 33, and drawn out through the draw-out path 34. Subsequently, the high-voltage terminal structure 21 is inserted deeply into the boot 30, and held by the terminal enclosure 33. Meanwhile, the cylindrical guide 28 is extended downwardly, so that the cylindrical guide 28 is contained in the glass portion enclosure 31.

The plug-side connector structure for high-voltage cable K is mounted in the above manner, and then connected to a spark plug P.

The spark plug P is installed in an internal-combustion engine. The terminal tip Pt and subsequent glass portion Pg of the spark plug P are inserted into the boot 30 from below. The terminal tip Pt is then inserted into the cylindrical guide 28 which is placed inside the glass portion enclosure 31. At this stage, the glass portion Pg abuts against the lowermost edge 28b of the cylindrical guide 28. The terminal tip Pt and glass portion Pg are then pushed deeply into the boot 30, so that the glass portion Pg pushes the cylindrical guide 28 upwardly. The latter is thus moved up towards the retracted position. Then, as the terminal tip Pt is contained in the cylindrical guide 28, the former is also led into the fitting body 26. Finally, the cylindrical guide 28 is moved up to the completely retracted point and arranged into the terminal enclosure 33. At the same time, the terminal tip Pt is inserted into the fitting body 26 and connected therein. The connecting operation between the plug-side connector structure and the spark plug P is thus completed. In such a structure, the terminal tip Pt will not risk hooking with the opened edge of the fitting body 26, and the terminal tip Pt will be smoothly inserted into the plug-fit system 25 of the high-voltage terminal structure 21.

When the plug-side connector structure is completely fitted to the spark plug P, the cylindrical guide 28 is retracted and arranged in the terminal enclosure 33. In this state, the inner circular face of the glass portion enclosure 31 is hermetically attached to the outer circular face of the glass portion Pg, so that electrical current is prevented from leaking out along the glass portion surface.

According to a first aspect of the invention, the plug-side connector structure for a high-voltage cable includes a boot, the boot having a substantially cylindrical form with first and second ends and configured to contain a high-voltage terminal structure attached to an end of a high-voltage cable which extends outwardly through the first end of the boot. The boot is further configured to receive, through the second end thereof, a terminal tip and subsequent glass portion of a spark plug so as to be connected to the high-voltage terminal structure.

Further, the high-voltage terminal structure includes a cable connector system connected to the one end of the high-voltage cable, and a plug-fit system. Furthermore, the plug-fit system includes a fitting body having a cylindrical form and configured to receive the terminal tip, and a tapered guide extending outwardly in the radial direction so as to form a flared end. Further, the boot includes a terminal enclosure for containing the high-voltage terminal structure, and a glass portion enclosure configured to contain the glass portion and located adjacent the second end of the boot. Then, the flared end of the tapered guide has an outermost external diameter greater than the internal diameter of the glass portion enclosure, and the glass portion enclosure and the terminal enclosure respectively include a internal circular face, the border of which is provided with a circular recess, such that, when the high-voltage terminal structure is contained in the terminal enclosure, the tapered guide is fitted into the circular recess.

In such a structure, when the terminal tip is inserted into the boot from its second end and is connected to the high-voltage terminal structure, the terminal tip can be guided very smoothly into the fitting body by the tapered guide. During this operation, the terminal tip is efficiently prevented from being hooked by the opening edge of the fitting body, and is smoothly connected to the high-voltage terminal structure.

In the above connector structure, the tapered guide of the high-voltage terminal structure is contained in the circular recess provided between the glass portion enclosure and the terminal enclosure. Accordingly, the flared-end of the tapered guide can have an external diameter substantially greater than the internal diameter of the glass portion enclosure. Accordingly, even if the terminal tip is inserted considerably askew with respect to the central axis of the high-voltage terminal structure, it can still be led into the fitting body very easily.

According to a second aspect of the invention, the plug-side connector structure for high-voltage cable is modified in that the tapered guide includes a circular edge having an outermost external diameter substantially the same as the internal diameter of the glass portion enclosure, such that, when the high-voltage terminal structure is contained in the terminal enclosure, the circular edge is hermetically attached to the internal circular face of the glass portion enclosure.

When the terminal tip is inserted into the boot from its second end and fitted into the high-voltage terminal structure, it can be led into the fitting body by the tapered guide without risk of hooking with the opening edge of the fitting body. The terminal tip can thus be fitted into the high-voltage terminal structure very smoothly.

According to a third aspect of the invention, the cylindrical form of the fitting body has a given external diameter and a longitudinally extending surface line. Further, the flared end of the tapered guide has an outermost external diameter, and an external taper angle which is defined relative to the longitudinally extending surface line of the fitting body, such that the outermost external diameter of the tapered guide is about 1.4 to about 1.6 times greater than the external diameter of the fitting body, and the external taper angle of the tapered guide ranges between about 120° and about 150°.

In such a case, the terminal tip can be inserted into the high-voltage terminal structure very smoothly, and the latter can be mounted into the boot very easily. A lowering of the rigidity of the boot, due to a lengthened high-voltage terminal structure, can also be avoided.

According to a fourth aspect of the invention, the tapered guide is formed of a plurality of fins separated from one another in the circumferential direction of the tapered guide.

Such fins can be manufactured by simply notching a part of a sheet and inclining the notched-apart fins, so that each fin can keep a desired thickness and mechanical strength. These fins can also be produced very easily.

According to a fifth aspect of the invention, the plug-side connector structure for high-voltage cable includes a boot, the boot having a substantially cylindrical form with first and second ends and configured to contain a high-voltage terminal structure attached to an end of a high-voltage cable which extends outwardly through the first end of the boot, the boot being configured to receive, through the second end thereof, a terminal tip and subsequent glass portion of a spark plug so as to be connected to the high-voltage terminal structure. Further, the high-voltage terminal structure includes a cable connector system connected to the one end of the high-voltage cable, and a plug-fit system.

Then, the plug-fit system includes a fitting body having a cylindrical form and configured to receive the terminal tip and a cylindrical guide, respectively having a common cylinder axis, the cylindrical guide being fitted around the fitting body such that the former can be extended or retreated with respect to the latter along the common cylinder axis.

Further, the boot includes a terminal enclosure for containing the high-voltage terminal structure, and a glass portion enclosure configured to contain the glass portion and located adjacent the second end of the boot.

The cylindrical guide is extendable from the fitting body so as to be contained in the glass portion enclosure, and retractable such that, when the terminal tip and glass portion are inserted into the boot, the cylindrical guide can be pushed into the boot by the glass portion and the terminal tip can be led into the fitting body, whereby the high-voltage terminal structure is held in the terminal enclosure.

In such a structure, when the terminal tip is inserted into the boot and fitted into the high-voltage terminal structure, the terminal tip is led into the fitting body by the cylindrical guide without being hooked by the opening edge of the fitting body. The terminal tip can thus be smoothly fitted into the high-voltage terminal structure.

Although the invention has been described with reference to particular means, materials and embodiments, it is to be understood that the invention is not limited to the particulars disclosed and extends to all equivalents within the scope of the claims.

5941 The present disclosure relates to subject matter contained in priority Japanese Application No.2000-266837, filed on Sep. 4, 2000, which is herein expressly incorporated by reference in its entirety.

What is claimed:

1. A plug-side connector structure for a high-voltage cable comprising a boot, the boot having a generally cylindrical form with first and second ends, the first end including a terminal enclosure configured to contain a high-voltage terminal structure attached to an end of the high-voltage cable that extends outwardly through the first end of the boot, the second end of the boot including a glass or ceramic enclosure configured to receive a terminal tip and subsequent glass or ceramic portion of a spark plug such that the terminal tip can be fitted into the high-voltage terminal structure;
said high-voltage terminal structure comprising a cable connector system connected to said one end of the high-voltage cable, and a plug-fit system;
said plug-fit system including a fitting body having a generally cylindrical form and configured to receive the terminal tip;
said plug-fit system further including a guide device that guides the terminal tip into said fitting body.

2. The plug-side connector structure for a high-voltage cable according to claim 1, wherein said guide device comprises a tapered guide extending from said fitting body towards said second end of said boot, while enlarging in the radial direction of said fitting body so as to form a flared end.

3. The plug-side connector structure for a high-voltage cable according to claim 2, wherein said flared end of said tapered guide has an outermost external diameter greater than an internal diameter of said glass- or ceramic-portion enclosure.

4. The plug-side connector structure for a high-voltage cable according to claim 3, wherein said glass- or ceramic-portion enclosure and said terminal enclosure respectively include an internal circular face, between which is provided a circular recess, such that, when said high-voltage terminal structure is contained in said terminal enclosure, said tapered guide is fitted into said circular recess.

5. The plug-side connector structure for a high-voltage cable according to claim 3, wherein said cylindrical form of said fitting body has a given external diameter, such that said outermost external diameter of said tapered guide is about 1.4 to about 1.6 times greater than said external diameter of said fitting body.

6. The plug-side connector structure for a high-voltage cable according to claim 2, wherein said cylindrical form of said fitting body has a longitudinally extending surface line, and said tapered guide has an external taper angle which is defined relative to said longitudinally extending surface line of said fitting body, such that said external taper angle of said tapered guide ranges between about 120° and about 150°.

7. The plug-side connector structure for a high-voltage cable according to claim 5, wherein said cylindrical form of said fitting body has a longitudinally extending surface line, and said tapered guide has an external taper angle which is defined relative to said longitudinally extending surface line of said fitting body, such that said external taper angle of said tapered guide ranges between about 120° and about 150°.

8. The plug-side connector structure for a high-voltage cable according to claim 2, wherein said tapered guide is formed of a plurality of fins separated from one another in the circumferential direction of said tapered guide, and form a slit flared end equivalent to said flared end having said outermost external diameter.

9. The plug-side connector structure for a high-voltage cable according to claim 3, wherein said tapered guide is formed of a plurality of fins separated from one another in the circumferential direction of said tapered guide, and form a slit flared end equivalent to said flared end having said outermost external diameter.

10. The plug-side connector structure for a high-voltage cable according to claim 6, wherein said tapered guide is formed of a plurality of fins separated from one another in the circumferential direction of said tapered guide, and form a slit flared end equivalent to said flared end having said outermost external diameter.

11. The plug-side connector structure for a high-voltage cable according to claim 7, wherein said tapered guide is formed of a plurality of fins separated from one another in the circumferential direction of said tapered guide, and form a slit flared end equivalent to said flared end having said outermost external diameter.

11. The plug-side connection structure for a high-voltage cable according to claim 1, wherein said guid device comprises a tapered guide extending from said fitting body towards said second end of said boot, while enlarging in the radial direction of said fitting body so as to form a flared end;
said flared end has an outermost external diameter substantially the same as an internal diameter of said glass- or ceramic-portion enclosure portion, such that, when said high-voltage terminal structure is contained in said terminal enclosure, said circular edge is hermetically attached to said internal circular face of said glass- or ceramic-portion enclosure.

12. The plug-side connector structure for a high-voltage cable according to claim 1, wherein said guide device comprises a generally cylindrical guide having a common cylinder axis with said fitting body, said cylindrical guide being fitted around said fitting body;
said cylindrical guide is movably mounted on and extendable from said fitting body along said common cylinder axis so as to be contained in said glass- or ceramic-portion enclosure, and retractable such that, when said terminal tip and glass or ceramic portion are inserted into the boot, said cylindrical guide can be pushed into the boot by the glass or ceramic portion and the terminal tip can be led into said fitting body, whereby said high-voltage terminal structure is held in said terminal enclosure.
